(19) United States
(12) Patent Application Publication
(10) Pub. No.: US 2024/0380611 A1
(43) Pub. Date: Nov. 14, 2024

(54) DATA TRANSMISSION METHOD, RELATED APPARATUS, DEVICE, AND STORAGE MEDIUM

(71) Applicant: TENCENT TECHNOLOGY (SHENZHEN) COMPANY LIMITED, Shenzhen (CN)

(72) Inventors: Peng ZHANG, Shenzhen (CN); Wei SONG, Shenzhen (CN); Juguang ZHANG, Shenzhen (CN); Zhenhao NONG, Shenzhen (CN)

(21) Appl. No.: 18/779,483

(22) Filed: Jul. 22, 2024

Related U.S. Application Data
(63) Continuation of application No. PCT/CN2023/078315, filed on Feb. 27, 2023.

(30) Foreign Application Priority Data
May 16, 2022 (CN) 202210530907.3

(51) Int. Cl. H04L 9/32

(52) U.S. Cl. CPC H04L 9/3263

(57) ABSTRACT

A data transmission method includes receiving a first certificate transmitted by a first device, transmitting a second certificate to the first device, determining a first public key and a first terminal identity based on the first certificate in response to both the first certificate and the second certificate being valid certificates, receiving a data access request transmitted by the first device in response to both the first terminal identity and a second terminal identity being registered identities, and transmitting target data to the first device in response to the data access request.

### CROSS-REFERENCE TO RELATED APPLICATIONS

This application is a continuation of International Application No. PCT/CN2023/078315, filed on Feb. 27, 2023, which claims priority to Chinese Patent Application No. 2022105309073, filed with the China National Intellectual Property Administration on May 16, 2022 and entitled “DATA TRANSMISSION METHOD, RELATED APPARATUS, DEVICE, AND STORAGE MEDIUM,” the entire contents of both of which are incorporated herein by reference.

### FIELD OF THE TECHNOLOGY

This application relates to the field of security technologies and the field of the Internet of Vehicles technologies, and in particular, to a data transmission technology.

### BACKGROUND OF THE DISCLOSURE

In recent years, with the popularization of the Internet of Things and mobile networks, driving recorders have developed rapidly. A driving recorder is one of devices installed in a vehicle. The function of the driving recorder gradually develops from pure positioning recording to multi-dimensional information recording, thereby implementing functions such as remote collection of pictures and videos, analysis of driver's driving behaviors, real-time remote livestreaming, and positioning locations and trajectories.

At present, driving data collected by the driving recorder may be stored on a cloud device in a cloud transfer or cloud storage manner, and a key and a certificate are stored on a third-party server. When a vehicle owner wants to access the driving data collected by the driving recorder, the vehicle owner directly initiates an access request to the cloud device, and the cloud device returns the driving data to a user.

However, the existing solution has at least the following problems: The driving data is highly private, and there are still some potential security risks in storing the key and the certificate on the third-party server. That is, the driving data is easily stolen or tampered with during data transmission, leading to low security and reliability of data transmission.

### SUMMARY

In accordance with the disclosure, there is provided a data transmission method including receiving a first certificate transmitted by a first device, transmitting a second certificate to the first device, determining a first public key and a first terminal identity based on the first certificate in response to both the first certificate and the second certificate being valid certificates, receiving a data access request transmitted by the first device in response to both the first terminal identity and a second terminal identity being registered identities, and transmitting target data to the first device in response to the data access request. The first public key and a first private key are a key pair generated by the first device, and the first terminal identity is an identity corresponding to the first device. The data access request is encrypted by the first device using a second public key or the first private key. The second public key is obtained by the first device based on the second certificate. The second public key and a second private key are a key pair generated by a second device, and the second terminal identity is an identity corresponding to the second device. The target data is encrypted data obtained through encryption using the first public key or the second private key.

Also in accordance with the disclosure, there is provided a computer device including one or more processors, and one or more memories storing one or more program instructions that, when executed by the one or more processors, cause the one or more processors to receive a first certificate transmitted by a first device, transmit a second certificate to the first device, determine a first public key and a first terminal identity based on the first certificate in response to both the first certificate and the second certificate being valid certificates, receive a data access request transmitted by the first device in response to both the first terminal identity and a second terminal identity being registered identities, and transmit target data to the first device in response to the data access request. The first public key and a first private key are a key pair generated by the first device, and the first terminal identity is an identity corresponding to the first device. The data access request is encrypted by the first device using a second public key or the first private key. The second public key is obtained by the first device based on the second certificate. The second public key and a second private key are a key pair generated by a second device, and the second terminal identity is an identity corresponding to the second device. The target data is encrypted data obtained through encryption using the first public key or the second private key.

Also in accordance with the disclosure, there is provided a data transmission method performed by a first device and including transmitting a first certificate to a second device, and receiving a second certificate transmitted by the second device. The first device is configured to generate a first key pair including a first public key and a first private key. A first terminal identity corresponds to the first device. The second device is configured to generate a second key pair including a second public key and a second private key. A second terminal identity corresponds to the second device. The method further includes determining the second public key and the second terminal identity based on the second certificate in response to both the first certificate and the second certificate being valid certificates, transmitting a data access request to the second device in response to both the first terminal identity and the second terminal identity being registered identities, and receiving target data transmitted by the second device. The data access request is encrypted by the first device using the second public key or the first private key. The target data is encrypted data obtained through encryption using the first public key or the second private key.

### BRIEF DESCRIPTION OF THE DRAWINGS

FIG. 1 is a schematic architectural diagram of a data transmission system according to an embodiment of this application.

FIG. 2 is a schematic diagram showing an environment of an Internet of Vehicles system according to an embodiment of this application.

FIG. 3 is a schematic flowchart of a data transmission method according to an embodiment of this application.

FIG. 4 is a schematic diagram showing a work flow of a car terminal based on an Internet of Vehicles system according to an embodiment of this application.

FIG. 5 is a schematic diagram showing an interface for unbinding a terminal identity according to an embodiment of this application.

FIG. 6 is a schematic diagram showing an interface for adding a terminal identity binding according to an embodiment of this application.

FIG. 7 is a schematic diagram showing communication of an intelligent connected vehicle according to an embodiment of this application.

FIG. 8 is a schematic diagram showing implementation of terminal communication based on a QR code according to an embodiment of this application.

FIG. 9 is a schematic diagram showing implementation of terminal communication based on manual input information according to an embodiment of this application.

FIG. 10 is another schematic flowchart of a data transmission method according to an embodiment of this application.

FIG. 11 is a schematic diagram showing a work flow of a mobile terminal based on an Internet of Vehicles system according to an embodiment of this application.

FIG. 12 is a schematic diagram showing an interaction process based on an Internet of Vehicles system according to an embodiment of this application.

FIG. 13 is a schematic diagram of a data transmission apparatus according to an embodiment of this application.

FIG. 14 is a schematic diagram of a data transmission apparatus according to another embodiment of this application.

FIG. 15 is a schematic structural diagram of a terminal according to an embodiment of this application.

### DESCRIPTION OF EMBODIMENTS

Nowadays, according to regulations, no third party other than the vehicle owner has access to the content collected by the driving recorder, including third-party service providers. This requires that even automobile companies themselves and solution providers cannot store keys of customers. In addition, it is required that the vehicle owner and the vehicle not deceive each other and the transmission content cannot be intercepted and cracked. Based on this, this application provides a secure data transmission solution based on a peer to peer (P2P) network.

As a new type of network application, P2P has some advantages that a client-server (C/S) mode does not have, which are mainly reflected in the expansion of information volume and the freedom and openness of anonymous services. The biggest advantage of P2P lies in that P2P can support reliable and convenient information query. In a P2P network, peer nodes share some of their owned resources. These shared resources provide services and content through networks and can be directly accessed by other peer nodes without an intermediate entity. It can be seen that peer nodes are both a resource provider (that is, a server) and a resource gainer (that is, a client) in the P2P network.

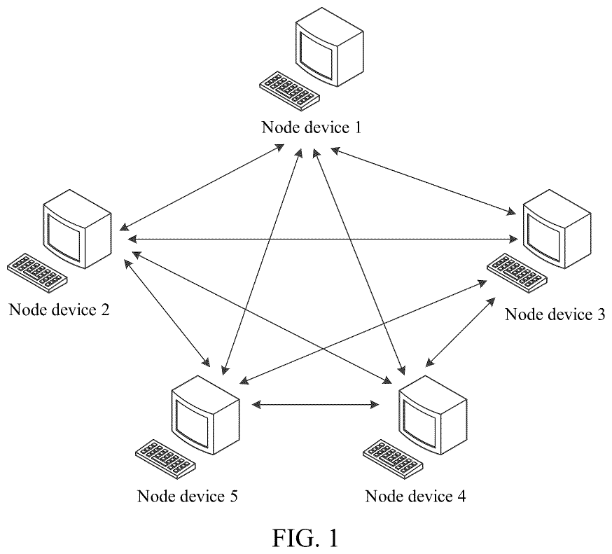

To improve security, privacy, and reliability of data transmission in the P2P network, this application provides a data transmission method. The method is applied to a data transmission system shown in FIG. 1. As shown in the figure, the data transmission system includes several node devices. The quantity of the node devices is not limited in this application. The node device may be a server or a terminal. In this application, an example in which the node device is a terminal is used for description. A client is deployed on the terminal, where the client may run on the terminal in the form of a browser, or may run on the terminal in the form of an independent application (APP). A specific display form of the client is not limited herein. The server involved in this application may be an independent physical server, or may be a server cluster including a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal may be a mobile phone, a computer, an intelligent voice interaction device, an intelligent household appliance, a car terminal, an aircraft, or the like, but is not limited thereto. The embodiments of this application may be applied to various scenarios, including but not limited to, cloud technology, artificial intelligence, intelligent transportation, assisted driving, and the like.

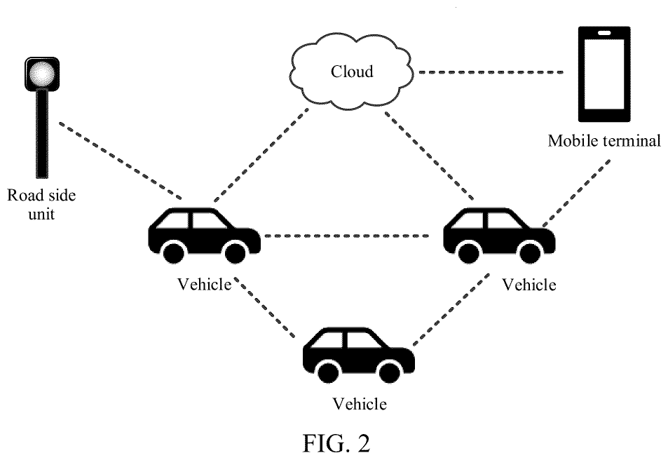

P2P promotes the development of the Internet of Vehicles industry. With the rapid development of automotive technologies, vehicles will develop toward networking and intelligence in the future. The deployment of various intelligent systems and communication technologies bring more possibilities to future transportation. For ease of understanding, referring to FIG. 2, FIG. 2 is a schematic diagram showing an environment of an Internet of Vehicles system according to an embodiment of this application. As shown in the figure, information sharing between vehicles, vehicles and devices, vehicles and roads, and vehicles and the cloud is implemented through information communication technologies. During communication of the Internet of Vehicles, an identity authentication system is established to give infrastructure such as a vehicle, a road side unit (RSU), and an information service platform a credible digital identity to resist security attacks such as information forgery and tampering.

The Internet of Vehicles is an application of the Internet of Things (IoT) in the automotive industry. The Internet of Things refers to a network for collecting in real time any objects or processes that need to be connected and interacted through various apparatuses and technologies such as an information sensor, a radio frequency recognition technology, a global positioning system, an infrared sensor, and a laser scanner, collecting various required information such as sound, light, heat, electricity, mechanics, chemistry, biology, and location, and implementing an ubiquitous connection between things and between things and people through various possible network accesses, to implement intelligent perception, recognition, and management of objects and processes. The Internet of Things is an information bearer based on the Internet and traditional telecom networks, and enables all ordinary physical objects that can be independently addressed to form a network that interconnects with each other.

Cloud IoT aims to connect information sensed and instructions received by a sensing device in the traditional Internet of Things to the Internet to truly implement networking and implement storage and calculation of massive data through a cloud computing technology. Since the characteristic of the Internet of Things is that things are connected to each other and a current operating state of each “object” is perceived in real time, a large amount of data information is generated in this process. How to summarize these information and how to filter out useful information from massive information to support decision-making for subsequent development has become a key issue affecting the development of the Internet of Things. Therefore, Cloud IoT based on the cloud computing and the cloud storage technology has become a strong support for the application of the Internet of Things technology.

In view of this, this application involves some terms related to professional fields. For ease of understanding, the related terms are explained below.

1. Vehicle: it generally refers to an intelligent vehicle or an intelligent connected vehicle.

2. Car terminal: it may be equipped with an in-vehicle system (that is, a system used by a vehicle), usually an Android system. The car terminal integrates a plurality of functions such as positioning, communication, and a driving recorder, and has a service scheduling function and a data processing capability. In this application, it is assumed that the in-vehicle system has high security and is uncrackable. Therefore, the private key in the in-vehicle system cannot be obtained.

3. Vehicle owner: the owner of the vehicle. It generally refers to a mobile terminal of the vehicle owner in this application, including but not limited to, a computer and a mobile phone. In this application, assuming that an account system of the mobile terminal has high security and does not allow other users to obtain data of the mobile terminal of the vehicle owner and the private key in the mobile terminal.

4. Public key and private key: asymmetric encryption key pair, where the private key is stored by the vehicle owner.

5. Terminal identity (TID): a unique identity (ID) of a device. Usually, the car terminal and the mobile terminal have their own TID.

6. Mobile ID (MID): it represents an ID of the mobile terminal. This part may also be provided by a vehicle owner account.

7. Car ID (CID): it represents a TID of the car terminal.

8. Vehicle owner account: a login account of an automobile company APP.

9. Certificate: it represents that a certain public key is a certificate file belonging to a certain TID, where the certificate is signed by an authority, and therefore can be verified.

10. Root certificate: a public key file of an authority, which is a self-signed certificate.

11. Authority: a certification authority (CA), is a core of public key infrastructure (PKI). It is mainly used to store a private key, provide a root certificate, and is responsible for issuing a certificate, authenticating a certificate, managing an issued certificate, and the like. Generally, traffic scheduling, session maintenance, and load balancing are completed in the authority.

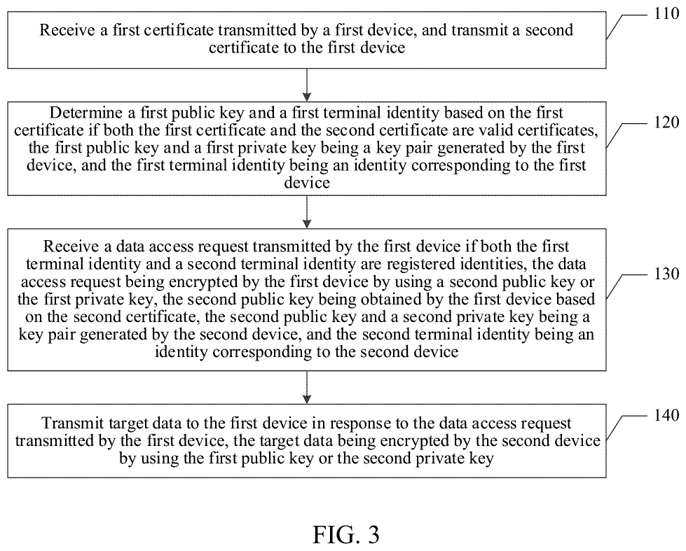

With reference to the foregoing description, a data transmission method in this application is described below. Referring to FIG. 3, the data transmission method in the embodiments of this application may be performed by a terminal. For example, the terminal may be a car terminal. The method includes:

110. A second device receives a first certificate transmitted by a first device, and transmits a second certificate to the first device.

In one or more embodiments, after the first device establishes a communication connection to the second device, the first device transmits the first certificate to the second device, and the second device transmits the second certificate to the first device. The first device may be a mobile terminal (for example, a mobile phone, a tablet computer, or a computer), and the second device may be a car terminal.

Specifically, after the mobile terminal establishes a communication connection to the car terminal, the mobile terminal transmits the first certificate to the car terminal. Therefore, the car terminal receives the first certificate. Similarly, the car terminal transmits the second certificate to the mobile terminal. Therefore, the mobile terminal receives the second certificate.

120. The second device determines a first public key and a first terminal identity based on the first certificate if both the first certificate and the second certificate are valid certificates, the first public key and a first private key being a key pair generated by the first device, and the first terminal identity being an identity corresponding to the first device.

In one or more embodiments, the second device verifies validity of the first certificate, and the first device verifies validity of the second certificate. If both the first certificate and the second certificate are valid certificates, the second device may determine a public key in the first certificate as the first public key, and determine a terminal identity in the first certificate as the first terminal identity. Similarly, the first device may determine a public key in the second certificate as the second public key, and determine a terminal identity in the second certificate as the second terminal identity. The first public key and the first private key are a key pair generated by the first device, and the first terminal identity is an identity corresponding to the first device. The second public key and the second private key are a key pair generated by the second device, and the second terminal identity is an identity corresponding to the second device.

Specifically, the car terminal obtains the first public key and the first terminal identity based on the first certificate, where the first public key and the first private key are a key pair generated by the mobile terminal, that is, the first public key may be a mobile terminal public key, and the first private key may be a mobile terminal private key. The first terminal identity is a TID of the mobile terminal, that is, an MID. Similarly, the mobile terminal obtains the second public key and the second terminal identity based on the second certificate, where the second public key and the second private key are a key pair generated by the car terminal, that is, the second public key may be a car terminal public key, and the second private key may be a car terminal private key. The second terminal identity is a TID of the car terminal, that is, a CID.

130. The second device receives a data access request transmitted by the first device if both the first terminal identity and a second terminal identity are registered identities, the data access request being encrypted by the first device by using a second public key or the first private key, the second public key being obtained by the first device based on the second certificate, the second public key and a second private key being a key pair generated by the second device, and the second terminal identity being an identity corresponding to the second device.

In one or more embodiments, the second device detects a registration status of the first terminal identity, and the first device detects a registration status of the second terminal identity. If both the first terminal identity and the second terminal identity are registered identities, the first device may encrypt the data access request by using the second public key or the first private key. Based on this, the first device transmits the data access request to the second device.

Specifically, the mobile terminal encrypts the data access request by using the car terminal public key or the mobile terminal private key. Based on this, the mobile terminal transmits the data access request to the car terminal.

140. The second device transmits target data to the first device in response to the data access request transmitted by the first device, the target data being encrypted by the second device by using the first public key or the second private key.

In one or more embodiments, the second device encrypts original data by using the first public key or the second private key in response to the data access request transmitted by the first device, to obtain the target data. Therefore, the second device transmits the target data to the first device.

Specifically, the car terminal encrypts, in response to the data access request, the original data by using the mobile terminal public key or the car terminal private key to obtain the target data. Then, the car terminal transmits the target data to the mobile terminal. The original data may be driving data collected by the driving recorder, including but not limited to, speech, photos, video records, and the like collected during driving.

The embodiments of this application provide a data transmission method. Through the foregoing manner, a key and certificate system is extended to a decentralized P2P network, so that terminals (for example, a car terminal and a mobile terminal) in the P2P network can use a key and a certificate that are locally stored to implement identity authentication, thereby improving security, privacy, and reliability of data transmission between the terminals.

In some embodiments, based on the foregoing embodiments corresponding to FIG. 3, in another optional embodiment provided in the embodiments of this application, before the second device transmits the second certificate to the first device, the method may further include:
the second device obtains the second public key and the second private key;
the second device stores the second private key;
the second device transmits the second public key and the second terminal identity to an authentication server, so that the authentication server signs the second public key and the second terminal identity by using a target private key, to obtain the second certificate; and
the second device receives the second certificate transmitted by the authentication server.

In one or more embodiments, a manner for the second device to apply to an authority for a certificate is described. It can be learned from the foregoing embodiments that before transmitting the second certificate to the first device, the second device needs to apply to the authority for the second certificate. First, the second device generates the key pair, that is, the second public key and the second private key. On one hand, the second device needs to store the second private key locally. On the other hand, the second device needs to transmit the second public key and the second terminal identity to an authentication server of the authority, for the authentication server to sign the second public key and the second terminal identity by using a target private key of the authentication server, to obtain the second certificate. Finally, the authentication server feeds back the second certificate to the second device.

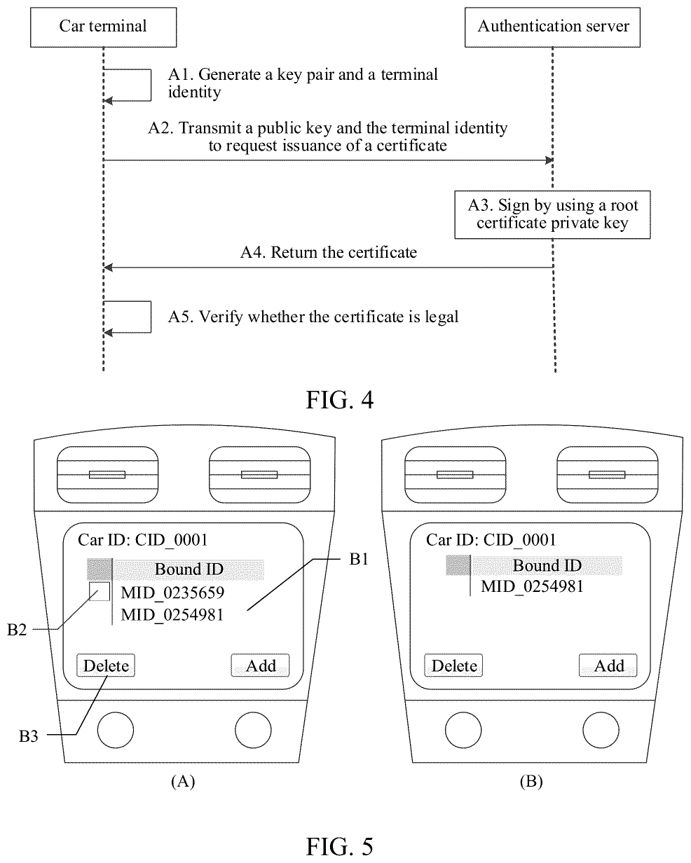

For example, the second device is a car terminal. For ease of understanding, referring to FIG. 4, FIG. 4 is a schematic diagram showing a work flow of a car terminal based on an Internet of Vehicles system according to an embodiment of this application. As shown in the figure, specifically,
in operation A1, the car terminal is pre-installed with a root certificate of the authority before delivery. During initialization after delivery, the car terminal generates the key pair (that is, the car terminal public key and the car terminal private key). The car terminal private key is stored by the car terminal itself and is not leaked. It can be seen that, no device other than the car terminal can learn the car terminal private key.

The key pair may be generated by using an algorithm or by using an encryption chip. This is not limited herein.

In operation A2, the car terminal obtains its own CID and binds the car terminal public key. Based on this, the car terminal initiates a Hyper Text Transfer Protocol over Secure Socket Layer (HTTPS) request or a Transport Layer Security (TLS) request to the authentication server of the authority to apply for issuance of a certificate.

In operation A3, after receiving the request transmitted by the car terminal, the authentication server of the authority may perform digital signature on the CID and the car terminal public key by using the target private key (that is, a root certificate private key) to form a certificate (that is, the second certificate).

In operation A4, the authentication server of the authority feeds back the certificate (that is, the second certificate) to the car terminal through an HTTPS channel or a TLS channel, thereby minimizing the risk of the car terminal being hijacked to obtain a wrong certificate. Based on this, the certificate (that is, the second certificate) is stored by the car terminal.

In operation A5, after receiving the certificate (that is, the second certificate), the car terminal verifies whether a signature of the certificate (that is, the second certificate) is correct through the root certificate pre-installed in operation A1 to ensure legality of the certificate.

Based on the foregoing process, the car terminal has a key pair (that is, the car terminal public key and the car terminal private key) bound to its own CID and the certificate system, and other visitors may communicate with the car terminal securely.

Then, the embodiments of this application provide a manner for the second device to apply to the authority for a certificate. Through the foregoing manner, the node device has a corresponding certificate. The certificate is authenticated and can confirm an identity of an information transmitter. Therefore, in combination with a manner of exchanging certificates between the node devices, communication between devices can be made more secure and reliable.

In some embodiments, based on the foregoing embodiments corresponding to FIG. 3, in another optional embodiment provided in the embodiments of this application, after the second device receives the second certificate transmitted by the authentication server, the method may further include:
the second device decrypts the second certificate by using a target public key to obtain a second target signature, the target public key and the target private key being a key pair generated by the authentication server;
the second device performs hash calculation on the second public key and the second terminal identity to obtain a second target digest; and
the second device stores the second certificate if the second target signature is consistent with the second target digest.

In one or more embodiments, a manner for the second device to verify the second certificate is described. It can be learned from the foregoing embodiments that the second device is pre-installed with the root certificate of the authority before delivery. The root certificate includes the target public key, and the target public key and the target private key are a key pair generated by the authority (that is, the authentication server). Based on this, the second certificate is decrypted by using the target public key to obtain the second target signature. In addition, the second device needs to perform hash calculation on a plaintext second public key and the second terminal identity to obtain the second target digest. If the second target signature is consistent with the second target digest, it represents that the second certificate received by the second device is a valid certificate. Therefore, the second device stores the second certificate locally.

Specifically, for example, the second device is the car terminal. The second certificate is decrypted by using the target public key to obtain the second target signature, that is:

signature_2=publickey_CA(DC_2), where
signature_2 represents the second target signature; publickey_CA represents the target public key generated by the authority; and DC_2 represents the second certificate.

The second device performs hash calculation on the second public key and the second terminal identity to obtain a second target digest, that is:

digest_2=hash(publickey_2+CID), where
digest_2 represents the second target digest; hash( ) represents hash calculation;
publickey_2 represents the second public key; and CID represents the second terminal identity.

Based on this, if the second target signature (that is, signature_2) is consistent with the second target digest (that is, digest_2), it represents that the second certificate is a valid certificate. On the contrary, if the second target signature is inconsistent with the second target digest, the second device may re-apply to the authority for issuance of the certificate.

Next, the embodiments of this application provide a manner for the second device to verify the second certificate. Through the foregoing manner, after obtaining the second certificate, the second device may verify legality of the second certificate. In this way, the legality of the certificate locally stored in the second device is ensured to improve the security and reliability of communication.

In some embodiments, based on the foregoing embodiments corresponding to FIG. 3, in another optional embodiment provided in the embodiments of this application, after the second device receives the first certificate transmitted by the first device, the method may further include:
the second device decrypts the first certificate by using a target public key to obtain a first digital signature, the target public key being a public key generated by the authentication server;
the second device obtains a first to-be-verified public key and a first to-be-verified identity from the first certificate;
the second device performs hash calculation on the first to-be-verified public key and the first to-be-verified identity to obtain a first message digest; and
the second device determines that the first certificate is a valid certificate if the first message digest is consistent with the first digital signature.

In this disclosure, a to-be-verified public key is also referred to as a “candidate public key,” and a to-be-verified identity is also referred to as a “candidate identity.”

That the second device determines a first public key and a first terminal identity based on the first certificate may specifically include:
the second device uses the first to-be-verified public key in the first certificate as the first public key, and uses the first to-be-verified identity in the first certificate as the first terminal identity.

In one or more embodiments, a manner for the second device to verify the first certificate is described. It can be learned from the foregoing embodiments that the second device is pre-installed with the root certificate of the authority before delivery. The root certificate includes the target public key. Based on this, the second device may decrypt the first certificate by using the target public key to obtain the first digital signature. In addition, the second device may obtain a plaintext first to-be-verified public key and the first to-be-verified identity from the first certificate, and then perform hash calculation on the first to-be-verified public key and the first to-be-verified identity to obtain the first message digest. If the first message digest is consistent with the first digital signature, it represents that the first certificate received by the second device is a valid certificate. Therefore, the second device may use the first to-be-verified public key in the first certificate as the first public key, and use the first to-be-verified identity in the first certificate as the first terminal identity.

Specifically, for example, the second device is the car terminal. The first certificate is decrypted by using the target public key to obtain the first target signature, that is:

signature_A=publickey_CA(DC_A), where
signature_A represents the first digital signature; publickey_CA represents the target public key generated by the authority; and DC_A represents the first certificate.

Hash calculation is performed on the first to-be-verified public key and the first to-be-verified identity to obtain a first message digest, that is:

digest_A=hash(publickey_A+MID_A), where
digest_A represents the first message digest; hasho represents hash calculation; publickey_A represents the first to-be-verified public key; and MID_A represents the first to-be-verified identity.

Based on this, if the first target signature (that is, signature_A) is consistent with the first message digest (that is, digest_A), it represents that the first certificate is a valid certificate. On the contrary, if the first target signature is inconsistent with the first message digest, the second device does not transmit data to the first device.

Then, the embodiments of this application provide a manner for the second device to verify the first certificate. Through the foregoing manner, after obtaining the first certificate, the second device may further verify validity of the first certificate to prevent other devices from using a forged certificate to request data, thereby improving security and reliability of communication.

In some embodiments, based on the foregoing embodiments corresponding to FIG. 3, in another optional embodiment provided in the embodiments of this application, that the second device transmits target data to the first device in response to the data access request transmitted by the first device may specifically include:
the second device decrypts the data access request by using the second private key to obtain request data if the data access request is encrypted by the first device by using the second public key;
the second device obtains original data based on the request data;
the second device encrypts the original data by using the second private key to obtain the target data; and
the second device transmits the target data to the first device, so that the first device decrypts the target data by using the second public key, to obtain the original data;
or
the second device decrypts the data access request by using the second private key to obtain request data if the data access request is encrypted by the first device by using the second public key;
the second device obtains original data based on the request data;
the second device encrypts the original data by using the first public key to obtain the target data; and
the second device transmits the target data to the first device, so that the first device decrypts the target data by using the first private key, to obtain the original data;
or
the second device decrypts the data access request by using the first public key to obtain request data if the data access request is encrypted by the first device by using the first private key;
the second device obtains original data based on the request data;
the second device encrypts the original data by using the second private key to obtain the target data; and
the second device transmits the target data to the first device, so that the first device decrypts the target data by using the second public key, to obtain the original data;
or
the second device decrypts the data access request by using the first public key to obtain request data if the data access request is encrypted by the first device by using the first private key;
the second device obtains original data based on the request data;
the second device encrypts the original data by using the first public key to obtain the target data; and
the second device transmits the target data to the first device, so that the first device decrypts the target data by using the first private key, to obtain the original data.

In one or more embodiments, a plurality of manners for secure communication based on different keys are described. It can be learned from the foregoing embodiments that the second device locally stores the second private key, and the second device can obtain the first public key. The first device locally stores the first private key, and the first device can obtain the second public key.

An example in which the first device is the mobile terminal and the second device is the car terminal is used for description below. The first public key is the mobile terminal public key, the first private key is the mobile terminal private key, the second public key is the car terminal public key, and the second private key is the car terminal private key. It is assumed that a user chooses to view driving data from 15:00 to 17:00 on May 3, 2022 through the mobile terminal. Therefore, request data of the user is obtained.

### Manner 1:

The mobile terminal may encrypt the request data by using the car terminal public key to obtain the data access request. Therefore, the mobile terminal transmits the data access request to the car terminal, and the car terminal may decrypt the data access request by using the car terminal private key to obtain the request data. The car terminal calls corresponding driving data as the original data based on the request data. Then, the car terminal encrypts the original data by using the car terminal private key to obtain the target data. The car terminal transmits the target data to the mobile terminal, and the mobile terminal may decrypt the target data by using the car terminal public key to obtain the original data.

### Manner 2:

The mobile terminal may encrypt the request data by using the car terminal public key to obtain the data access request. Therefore, the mobile terminal transmits the data access request to the car terminal, and the car terminal may decrypt the data access request by using the car terminal private key to obtain the request data. The car terminal calls corresponding driving data as the original data based on the request data. Then, the car terminal encrypts the original data by using the mobile terminal public key to obtain the target data. The car terminal transmits the target data to the mobile terminal, and the mobile terminal may decrypt the target data by using the mobile terminal private key to obtain the original data.

### Manner 3:

The mobile terminal may encrypt the request data by using the mobile terminal private key to obtain the data access request. Therefore, the mobile terminal transmits the data access request to the car terminal, and the car terminal may decrypt the data access request by using the mobile terminal public key to obtain the request data. The car terminal calls corresponding driving data as the original data based on the request data. Then, the car terminal encrypts the original data by using the car terminal private key to obtain the target data. The car terminal transmits the target data to the mobile terminal, and the mobile terminal may decrypt the target data by using the car terminal public key to obtain the original data.

### Manner 4:

The mobile terminal may encrypt the request data by using the mobile terminal private key to obtain the data access request. Therefore, the mobile terminal transmits the data access request to the car terminal, and the car terminal may decrypt the data access request by using the mobile terminal public key to obtain the request data. The car terminal calls corresponding driving data as the original data based on the request data. Then, the car terminal encrypts the original data by using the mobile terminal public key to obtain the target data. The car terminal transmits the target data to the mobile terminal, and the mobile terminal may decrypt the target data by using the mobile terminal private key to obtain the original data.

Then, the embodiments of this application provide a plurality of manners for secure communication based on different keys. Through the foregoing manner, the second device may select a corresponding key for encryption or decryption according to an actual situation, thereby increasing feasibility and flexibility of the solution.

In some embodiments, based on the foregoing embodiments corresponding to FIG. 3, in another optional embodiment provided in the embodiments of this application, after the second device determines the first public key and the first terminal identity based on the first certificate, the method may further include:
the second device obtains a first terminal identity set stored by the second device, the first terminal identity set including M first registration ting identities registered for the second device, and M being an integer greater than or equal to 1; and
the second device determines that the first terminal identity is a registered identity if the first terminal identity successfully matches a first registration terminal identity in the first terminal identity set.

In one or more embodiments, a manner for determining whether the first terminal identity is a registered identity is described. It can be learned from the foregoing embodiments that the first device may register the first terminal identity to the second device through a Bluetooth protocol or another secure channel. Based on this, the second device needs to perform matching on the received first terminal identity. If the matching is successful, it represents that the first device is a registered device, that is, it is determined that the first terminal identity is a registered identity.

Specifically, an example in which the first device is the mobile terminal and the second device is the car terminal is used for description below. The user may bind M MIDs to the car terminal, that is, M mobile terminals are allowed to communicate with one car terminal. For ease of understanding, referring to Table 1, Table 1 shows M MIDs that are registered to the car terminal.

TABLE 1

| CID | MID |
|---|---|
| CID_0001 | MID_0235659 |
| CID_0001 | MID_0254981 |
| CID_0001 | MID_0264154 |

It can be seen that, the same car terminal (that is, the same CID) may be bound to at least one MID. Table 1 is used as an example. A car terminal with CID “CID_0001” has three registered first registration ting identities, where the three first registration ting identities are MID_0235659, MID_0254981, and MID_0264154 respectively.

Then, the embodiments of this application provide a manner for determining whether the first terminal identity is a registered identity. Through the foregoing manner, the first device may register the first terminal identity of the first device to the second device, for the second device to store the first terminal identity. By verifying the terminal identity, whether the terminal identity is the same as the registered identity may be determined, so that security and reliability of device communication is improved.

In some embodiments, based on the foregoing embodiments corresponding to FIG. 3, in another optional embodiment provided in the embodiments of this application, the method may further include:
the second device displays the first terminal identity set; and
the second device removes, in response to a deletion operation for K first registration ting identities in the first terminal identity set, the K first registration ting identities from the first terminal identity set to obtain an updated first terminal identity set, K being an integer greater than or equal to 1 and less than or equal to M.

The method may further include:
the second device displays an identity adding control;
the second device displays an identity adding region in response to a selection operation for the identity adding control; and
the second device adds T first registration ting identities to the first terminal identity set in response to an input operation for the identity adding region, to obtain an updated first terminal identity set, T being an integer greater than or equal to 1.

In one or more embodiments, a manner for binding or unbinding the terminal identity is described. It can be learned from the foregoing embodiments that the second device further supports a function of displaying the first terminal identity set. Based on this, the CID and the MID may be bound or unbound. An example in which the second device is the car terminal is used with reference to the accompanying drawings below to describe a process of binding and unbinding an identity.

### 1. Unbind a Terminal Identity.

Specifically, for ease of understanding, referring to FIG. 5, FIG. 5 is a schematic diagram showing an interface for unbinding a terminal identity according to an embodiment of this application. As shown in (A) of FIG. 5, B1 is used to indicate an MID list bound to “CID_0001”, where there are currently 2 MIDs bound to “CID_0001”. B2 is used to indicate a selected MID. Since only one MID is selected here, K is equal to 1. A manner for selecting MID includes, but not limited to, long press, double-click, or click on a control. This is not limited herein. B3 is used to indicate a deletion control. After selecting K MIDs, the user clicks the deletion control indicated by B3 to display an interface shown in (B) of FIG. 5. In this case, the selected “MID_0235659” is unbound from “CID 0001”.

### 2. Add a Terminal Identity Binding.

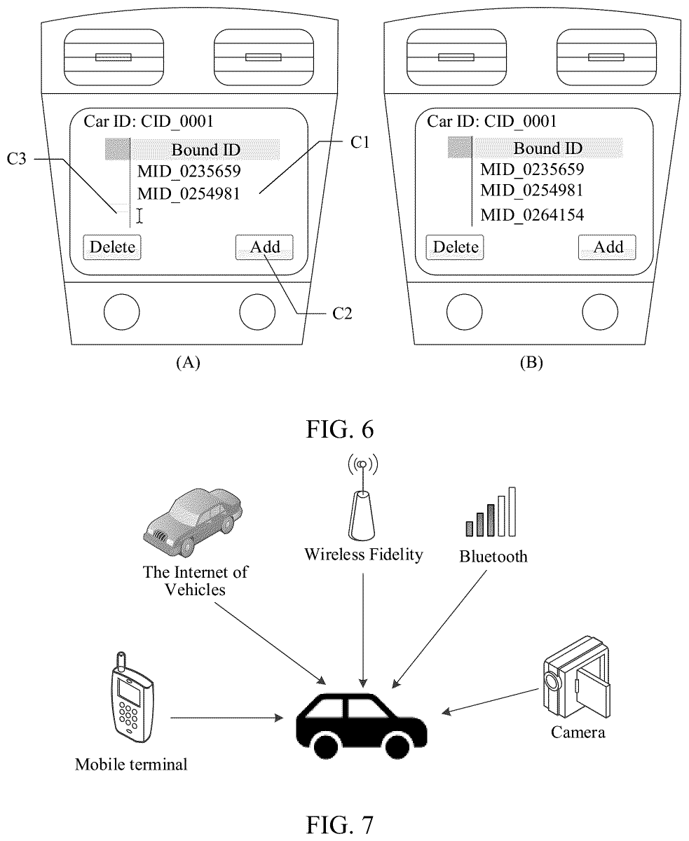

Specifically, for ease of understanding, referring to FIG. 6, FIG. 6 is a schematic diagram showing an interface for adding a terminal identity binding according to an embodiment of this application. As shown in (A) of FIG. 6, C1 is used to indicate an MID list bound to “CID_0001”, where there are currently 2 MIDs bound to “CID_0001”. C2 is used to indicate an identity adding control. After the user clicks on the identity adding control indicated by C2, the identity adding region indicated by C3 may be displayed. Based on this, the user may input a corresponding MID, for example, “MID_0264154”, in the identity adding region. Since only one MID is added here, T is equal to 1. After the input is completed, the interface shown in (B) of FIG. 6 may be displayed. In this case, the selected “MID_0264154” is successfully bound to “CID_0001”.

Next, the embodiments of this application provide a manner for binding or unbinding the terminal identity. Through the foregoing manner, if the mobile terminal of the user is no longer used, a previously bound MID may be deleted in the car terminal to avoid being used by lawbreakers. In addition, result visualization is implemented on the car terminal, so that even a malicious intrusion can be detected in time and a malicious access party can be eliminated.

In some embodiments, based on the foregoing embodiments corresponding to FIG. 3, in another optional embodiment provided in the embodiments of this application, before the second device receives the first certificate transmitted by the first device, and transmits the second certificate to the first device, the method may further include:
the second device establishes a Bluetooth connection to the first device when the second device and the first device enable a Bluetooth function, so that a communication connection is established between the second device and the first device;
or
the second device establishes a communication connection to the first device when the second device and the first device are connected to the same wireless fidelity;
or
the second device displays a QR code, the QR code including the second terminal identity; and
the second device establishes a communication connection to the first device when the first device scans the QR code;
or
the second device displays an information input region; and
the second device establishes a communication connection to the first device in response to the first terminal identity inputted for the information input region.

In one or more embodiments, a plurality of manners for establishing a communication connection are described. It can be learned from the foregoing embodiments that data transmission may be performed after the first device establishes the communication connection to the second device. Therefore, an example in which the first device is the mobile terminal and the second device is the car terminal is used below to describe a manner for establishing a communication connection.

The car terminal is deployed on the intelligent connected vehicle. For ease of understanding, referring to FIG. 7, FIG. 7 is a schematic diagram showing communication of an intelligent connected vehicle according to an embodiment of this application. As shown in the figure, the intelligent connected vehicle usually has a Wireless Fidelity (Wi-Fi) function, a Bluetooth function, a camera function, a global positioning system (GPS) function, a radar function, a communication function, and the like. Based on this, the car terminal may have a built-in Wi-Fi function, a Bluetooth function, a GPS function, a communication function, and the like.

### Association Manner 1:

The car terminal and the mobile terminal may establish a connection by using near field communication. For example, both the car terminal and the mobile terminal enable the Bluetooth function and establish a communication connection based on the Bluetooth protocol.

### Association Manner 2:

The car terminal enables a Wi-Fi function, and the mobile terminal accesses the Wi-Fi corresponding to the car terminal. Therefore, the car terminal and the mobile terminal access the same wireless fidelity, that is, the car terminal and the mobile terminal establish a communication connection through the same Wi-Fi network.

### Association Manner 3:

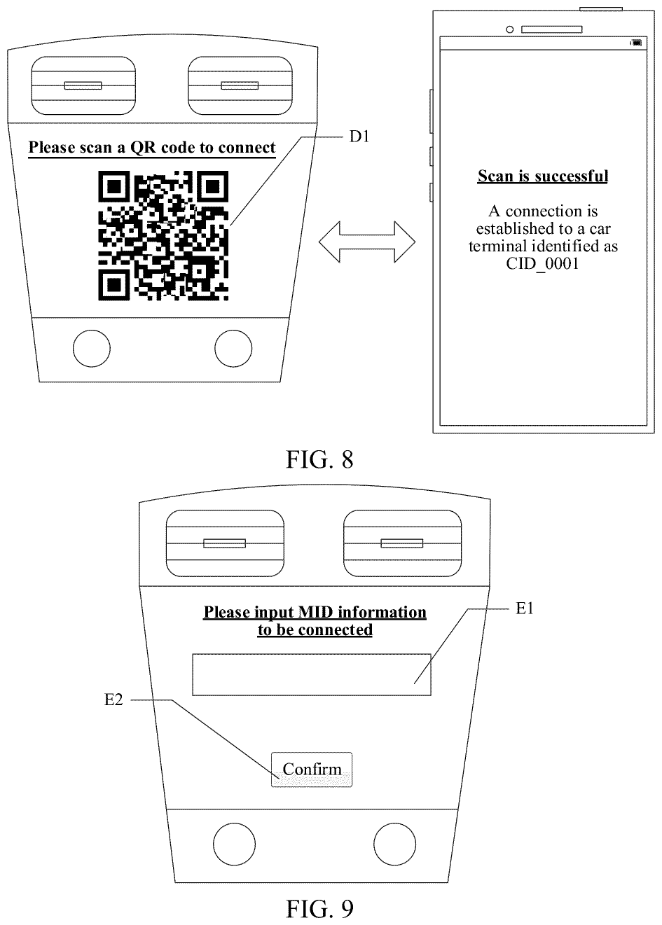

The car terminal displays a QR code for the mobile terminal to scan. For ease of understanding, referring to FIG. 8, FIG. 8 is a schematic diagram showing implementation of terminal communication based on a QR code according to an embodiment of this application. As shown in the figure, a QR code indicated by D1 is displayed on the car terminal, where the QR code includes a CID of the car terminal for the mobile terminal to obtain by scanning the QR code through a vehicle owner APP. Based on this, the mobile terminal may scan the QR code. After the scan is successful, a communication connection between the two devices is established.

### Association Manner 4:

The car terminal displays an information input region for the user to manually input an MID (for example, a vehicle owner account number, a system assigned identity number, or a mobile phone number). For ease of understanding, referring to FIG. 9, FIG. 9 is a schematic diagram showing implementation of terminal communication based on manual input information according to an embodiment of this application. As shown in the figure, E1 is used to indicate an information input region, and the user may input an MID (that is, a first terminal identity) in the information input region indicated by E1. After the input is completed, a confirmation control indicated by E2 is clicked to establish the communication connection between the two devices.

Then, the embodiments of this application provide a plurality of manners for establishing a communication connection. Through the foregoing manner, near field communication is used to add a trusted counterparty as a designated access party, which can avoid being tampered with and invaded in the case of public network communication. In addition, an asymmetric encryption and certificate system provides a great guarantee for security and credibility of data communication. This application may further adopt a more lightweight manner. That is, an agreed key may be simply exchanged during near field communication. After that, the key is directly used to encrypt the communication between the mobile terminal and the car terminal, and the key is no longer transmitted in a communication link, which also provides a good security effect. To further enhance security of the key, randomness and complexity of the key may further be checked, and the vehicle owner may be reminded to change the key regularly.

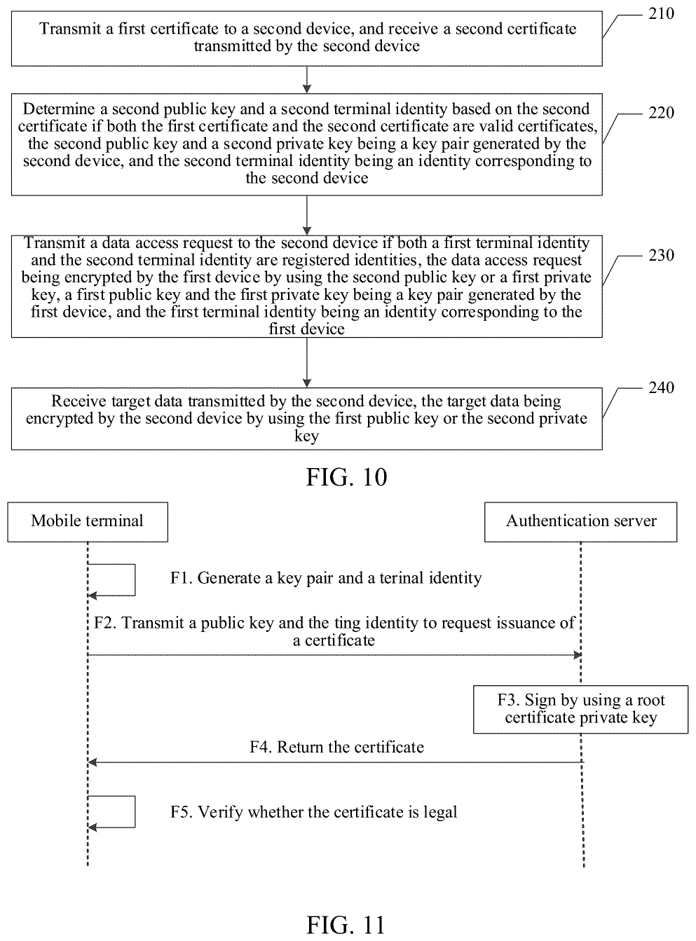

With reference to the foregoing description, a data transmission method in this application is described below. Referring to FIG. 10, the data transmission method in the embodiments of this application may be performed by a terminal. For example, the terminal may be a mobile terminal. The method includes:

210. A first device transmits a first certificate to a second device, and receives a second certificate transmitted by the second device.

In one or more embodiments, after the first device establishes a communication connection to the second device, the first device transmits the first certificate to the second device, and the second device transmits the second certificate to the first device. The first device may be a mobile terminal (for example, a mobile phone, a tablet computer, or a computer), and the second device may be a car terminal.

An execution process of operation 210 is similar to that of operation 110, and details are not described herein again.

220. The first device determines a second public key and a second terminal identity based on the second certificate if both the first certificate and the second certificate are valid certificates, the second public key and a second private key being a key pair generated by the second device, and the second terminal identity being an identity corresponding to the second device.

In one or more embodiments, the second device verifies validity of the first certificate, and the first device verifies validity of the second certificate. If both the first certificate and the second certificate are valid certificates, the second device may determine a public key in the first certificate as the first public key, and determine a terminal identity in the first certificate as the first terminal identity. Similarly, the first device may determine a public key in the second certificate as the second public key, and determine a terminal identity in the second certificate as the second terminal identity. The first public key and the first private key are a key pair generated by the first device, and the first terminal identity is an identity corresponding to the first device. The second public key and the second private key are a key pair generated by the second device, and the second terminal identity is an identity corresponding to the second device.

An execution process of operation 220 is similar to that of operation 120, and details are not described herein again.

230. The first device transmits a data access request to the second device if both a first terminal identity and the second terminal identity are registered identities, the data access request being encrypted by the first device by using the second public key or a first private key, a first public key and the first private key being a key pair generated by the first device, and the first terminal identity being an identity corresponding to the first device.

In one or more embodiments, the second device detects a registration status of the first terminal identity, and the first device detects a registration status of the second terminal identity. If both the first terminal identity and the second terminal identity are registered identities, the first device may encrypt the data access request by using the second public key or the first private key. Based on this, the first device transmits the data access request to the second device.

An execution process of operation 230 is similar to that of operation 130, and details are not described herein again.

240. The first device receives target data transmitted by the second device, the target data being encrypted by the second device by using the first public key or the second private key.

In one or more embodiments, the second device encrypts original data by using the first public key or the second private key in response to the data access request transmitted by the first device, to obtain the target data. Therefore, the second device transmits the target data to the first device.

An execution process of operation 240 is similar to that of operation 140, and details are not described herein again.

The embodiments of this application provide a data transmission method. Through the foregoing manner, a key and certificate system is extended to a decentralized P2P network, so that terminals (for example, a car terminal and a mobile terminal) in the P2P network can use a key and a certificate that are locally stored to implement identity authentication, thereby improving security, privacy, and reliability of data transmission between the terminals.

In some embodiments, based on the foregoing embodiments corresponding to FIG. 10, in another optional embodiment provided in the embodiments of this application, before the first device transmits the first certificate to the second device, the method may further include:
the first device obtains the first public key and the first private key;
the first device stores the first private key;
the first device transmits the first public key and the first terminal identity to an authentication server, so that the authentication server signs the first public key and the first terminal identity by using a target private key, to obtain the first certificate; and
the first device receives the first certificate transmitted by the authentication server.

In one or more embodiments, a manner for the first device to apply to an authority for a certificate is described. It can be learned from the foregoing embodiments that before transmitting the first certificate to the second device, the first device needs to apply to the authority for the first certificate. First, the first device generates the key pair, that is, the first public key and the first private key. On one hand, the first device needs to store the first private key locally. On the other hand, the first device needs to transmit the first public key and the first terminal identity to an authentication server of the authority, for the authentication server to sign the first public key and the first terminal identity by using a target private key of the authentication server, to obtain the first certificate. Finally, the authentication server feeds back the first certificate to the first device.

For example, the first device is a mobile terminal. For ease of understanding, referring to FIG. 11, FIG. 11 is a schematic diagram showing a work flow of a mobile terminal based on an Internet of Vehicles system according to an embodiment of this application. As shown in the figure, specifically,
in operation F1, the user downloads an APP to the mobile terminal, and the APP has a built-in root certificate of the authority. This process may be provided by a software development kit (SDK) of the APP. After the user logs in to the APP, a corresponding key pair (that is, a mobile terminal public key and a mobile terminal private key) is generated based on different MIDs (for example, a vehicle owner account, a system assigned identity number, or a mobile phone number). The mobile terminal private key is stored by the mobile terminal itself and is not leaked. It can be seen that, no device other than the mobile terminal can obtain the mobile terminal private key.

In operation F2, the mobile terminal binds the MID to the mobile terminal public key. Based on this, the mobile terminal initiates an HTTPS request or a TLS request to the authentication server of the authority to apply for issuance of a certificate.

In operation F3, after receiving the request transmitted by the mobile terminal, the authentication server of the authority may perform digital signature on the MID and the mobile terminal public key by using the target private key (that is, a root certificate private key) to form a certificate (that is, the first certificate).

In operation F4, the authentication server of the authority feeds back the certificate (that is, the first certificate) to the mobile terminal through an HTTPS channel or a TLS channel, thereby minimizing the risk of the mobile terminal being hijacked to obtain a wrong certificate. Based on this, the certificate (that is, the first certificate) is stored by the mobile terminal.

In operation F5, after receiving the certificate (that is, the first certificate), the mobile terminal verifies whether a signature of the certificate (that is, the first certificate) is correct through the root certificate pre-installed in operation F1 to ensure legality of the certificate.

Based on the foregoing process, the mobile terminal has a key pair (that is, the mobile terminal public key and the mobile terminal private key) bound to its own MID and the certificate system, and other visitors may communicate with the mobile terminal securely.

The APP of the mobile terminal may clear data. Therefore, when logging in again, whether the key pair (that is, the mobile terminal public key and the mobile terminal private key) and the certificate exist and are legal need to be re-verified. If the key pair and the certificate do not exist or are illegal, the key pair and the certificate need to be regenerated. The security of the APP is mainly ensured by the APP, that is, it mainly ensures that the private key of the APP cannot be obtained, and the encryption chip built in the APP system is used as much as possible.

Then, the embodiments of this application provide a manner for the first device to apply to the authority for a certificate. Through the foregoing manner, the node device has a corresponding certificate. The certificate is authenticated and can confirm an identity of an information transmitter. Therefore, in combination with a manner of exchanging certificates between the node devices, communication between devices can be made more secure and reliable.

In some embodiments, based on the foregoing embodiments corresponding to FIG. 10, in another optional embodiment provided in the embodiments of this application, after the first device receives the first certificate transmitted by the authentication server, the method may further include:
the first device decrypts the first certificate by using a target public key to obtain a first target signature, the target public key and the target private key being a key pair generated by the authentication server;
the first device performs hash calculation on the first public key and the first terminal identity to obtain a first target digest; and
the first device stores the first certificate if the first target signature is consistent with the first target digest.

In one or more embodiments, a manner for the first device to verify the first certificate is described. It can be learned from the foregoing embodiments that the first device has a built-in root certificate of the authority in a downloaded APP. The root certificate includes the target public key, and the target public key and the target private key are a key pair generated by the authority (that is, the authentication server). Based on this, the first certificate is decrypted by using the target public key to obtain the first target signature. In addition, the first device needs to perform hash calculation on the plaintext first public key and the first terminal identity to obtain the first target digest. If the first target signature is consistent with the first target digest, it represents that the first certificate received by the first device is a valid certificate. Therefore, the first device stores the first certificate locally.

Specifically, for example, the first device is the mobile terminal. The first certificate is decrypted by using the target public key to obtain the first target signature, that is:

signature_1=publickey_CA(DC_1), where

signature_1 represents the first target signature; publickey_CA represents the target public key generated by the authority; and DC_1 represents the first certificate.

The first device performs hash calculation on the first public key and the first terminal identity to obtain a first target digest, that is:

digest_1=hash(publickey_1+MID), where
digest_1 represents the first target digest; hash( ) represents hash calculation; publickey_1 represents the first public key; and MID represents the first terminal identity.

Based on this, if the first target signature (that is, signature_1) is consistent with the first target digest (that is, digest_1), it represents that the first certificate is a valid certificate. On the contrary, if the first target signature is inconsistent with the first target digest, the first device may re-apply to the authority for issuance of the certificate.

Next, the embodiments of this application provide a manner for the first device to verify the first certificate. Through the foregoing manner, after obtaining the first certificate, the first device may further verify legality of the first certificate. In this way, the legality of the certificate locally stored in the second device is ensured to improve the security and reliability of communication.

In some embodiments, based on the foregoing embodiments corresponding to FIG. 10, in another optional embodiment provided in the embodiments of this application, after the first device receives the second certificate transmitted by the second device, the method may further include:
the first device decrypts the second certificate by using a target public key to obtain a second digital signature, the target public key being a public key generated by the authentication server;
the first device obtains a second to-be-verified public key and a second to-be-verified identity from the second certificate;
the first device performs hash calculation on the second to-be-verified public key and the second to-be-verified identity to obtain a second message digest; and
the first device determines that the second certificate is a valid certificate if the second message digest is consistent with the second digital signature.

That the first device determines a second public key and a second terminal identity based on the second certificate may specifically include:
the first device uses the second to-be-verified public key in the second certificate as the second public key, and uses the second to-be-verified identity in the second certificate as the second terminal identity.

In one or more embodiments, a manner for the first device to verify the second certificate is described. It can be learned from the foregoing embodiments that the first device has a built-in root certificate of the authority in a downloaded APP. The root certificate includes the target public key. Based on this, the second certificate is decrypted by using the target public key to obtain the second digital signature. In addition, the first device may obtain a plaintext second to-be-verified public key and the second to-be-verified identity from the second certificate, and then perform hash calculation on the second to-be-verified public key and the second to-be-verified identity to obtain the second message digest. If the second message digest is consistent with the second digital signature, it represents that the second certificate received by the first device is a valid certificate. Therefore, the first device uses the second to-be-verified public key in the second certificate as the second public key, and uses the second to-be-verified identity in the second certificate as the second terminal identity.

Specifically, for example, the first device is the mobile terminal. The second certificate is decrypted by using the target public key to obtain the second digital signature, that is:

signature_B=publickey_CA(DC_B), where
signature_B represents the second digital signature; publickey_CA represents the target public key generated by the authority; and DC_B represents the second certificate.

The first device performs hash calculation on the second to-be-verified public key and the second to-be-verified identity to obtain a second message digest, that is:

digest_B=hash(publickey_B+CID_B), where
digest_B represents the second message digest; hash( ) represents hash calculation; publickey_B represents the second to-be-verified public key; and CID_B represents the second to-be-verified identity.

Based on this, if the second digital signature (that is, signature_B) is consistent with the second message digest (that is, digest_B), it represents that the second certificate is a valid certificate. On the contrary, if the second digital signature is inconsistent with the second message digest, the first device does not transmit a request to the second device.

Then, the embodiments of this application provide a manner for the first device to verify the second certificate. Through the foregoing manner, after obtaining the second certificate, the first device may further verify validity of the second certificate to prevent other devices from using a forged certificate to request data, thereby improving security and reliability of communication.

In some embodiments, based on the foregoing embodiments corresponding to FIG. 10, in another optional embodiment provided in the embodiments of this application, before the first device transmits the data access request to the second device, the method may further include:
the first device encrypts request data by using the second public key to obtain the data access request; and
after the first device transmits the data access request to the second device, the method may further include:
the first device transmits the data access request to the second device, so that the second device decrypts the data access request by using the second private key, to obtain the request data;
or
before the first device transmits the data access request to the second device, the method may further include:
the first device encrypts request data by using the first private key to obtain the data access request; and
after the first device transmits the data access request to the second device, the method may further include:
the first device transmits the data access request to the second device, so that the second device decrypts the data access request by using the first public key, to obtain the request data;
or
after the first device receives the target data transmitted by the second device, the method may further include:
the first device decrypts, if the target data is obtained by the second device encrypting original data by using the second private key, the target data by using the second public key to obtain the original data;
or
after the first device receives the target data transmitted by the second device, the method may further include:
the first device decrypts, if the target data is obtained by the second device encrypting original data by using the first public key, the target data by using the first private key to obtain the original data.

In one or more embodiments, a plurality of manners for secure communication based on different keys are described. It can be learned from the foregoing embodiments that the first device locally stores the first private key, and the first device can obtain the second public key. The second device locally stores the second private key, and the second device can obtain the first public key.

For the content described in this embodiment, refer to Manner 1, Manner 2, Manner 3, and Manner 4 in the foregoing embodiments. Details are not described herein again.

Then, the embodiments of this application provide a plurality of manners for secure communication based on different keys. Through the foregoing manner, the first device may select a corresponding key for encryption or decryption according to an actual situation, thereby increasing feasibility and flexibility of the solution.

In some embodiments, based on the foregoing embodiments corresponding to FIG. 10, in another optional embodiment provided in the embodiments of this application, after the first device determines the second public key and the second terminal identity based on the second certificate, the method may further include:
the first device obtains a second terminal identity set stored by the first device, the second terminal identity set including N second registration ting identities registered for the first device, and N being an integer greater than or equal to 1; and
the first device determines that the second terminal identity is a registered identity if the second terminal identity successfully matches a second registration terminal identity in the second terminal identity set.

In one or more embodiments, a manner for determining whether the terminal identity is a registered identity is described. It can be learned from the foregoing embodiments that the second device may register the second terminal identity to the first device through a Bluetooth protocol or another secure channel. Based on this, the first device needs to perform matching on the received second terminal identity. If the matching is successful, it represents that the second device is a registered device, that is, it is determined that the second terminal identity is a registered identity.

Specifically, an example in which the first device is the mobile terminal and the second device is the car terminal is used for description below. The user may bind N CIDs to the mobile terminal, that is, N car terminals are allowed to communicate with one mobile terminal. For ease of understanding, referring to Table 2, Table 2 shows N CIDs that are registered to the mobile terminal.

TABLE 2

| MID | CID |
|---|---|
| MID_0235659 | CID_0001 |
| MID_0235659 | CID_0006 |

It can be seen that, the same mobile terminal (that is, the same MID) may be bound to at least one CID. Table 2 is used as an example. A mobile terminal with MID “MID_0235659” has two registered second registration ting identities, where the two second registration ting identities are CID_0001 and CID_0006 respectively.

Then, the embodiments of this application provide a manner for determining whether the terminal identity is a registered identity. Through the foregoing manner, the second device may register the second terminal identity of the second device to the first device, for the APP of the first device to store. By verifying the terminal identity, whether the terminal identity is the same as the registered identity may be determined, so that security and reliability of device communication is improved.

In some embodiments, based on the foregoing embodiments corresponding to FIG. 10, in another optional embodiment provided in the embodiments of this application, before the first device transmits the first certificate to the second device, and receives the second certificate transmitted by the second device, the method may further include:
the first device establishes a Bluetooth connection to the second device when the second device and the first device enable a Bluetooth function, so that a communication connection is established between the second device and the first device;
or
the first device establishes a communication connection to the second device when the second device and the first device are connected to the same wireless fidelity;
or
the first device scans a QR code displayed on the second device to establish a communication connection to the first device, the QR code including the second terminal identity.

In one or more embodiments, a plurality of manners for establishing a communication connection are described. It can be learned from the foregoing embodiments that data transmission may be performed after the first device establishes the communication connection to the second device. For the content described in this embodiment, refer to Association manner 1, Association manner 2, and Association manner 3 in the foregoing embodiments. Details are not described herein again.

Then, the embodiments of this application provide a plurality of manners for establishing a communication connection. Through the foregoing manner, near field communication is used to add a trusted counterparty as a designated access party, which can avoid being tampered with and invaded in the case of public network communication. In addition, an asymmetric encryption and certificate system provides a great guarantee for security and credibility of data communication. This application may further adopt a more lightweight manner. That is, an agreed key may be simply exchanged during near field communication. After that, the key is directly used to encrypt the communication between the mobile terminal and the car terminal, and the key is no longer transmitted in a communication link, which also provides a good security effect. To further enhance security of the key, randomness and complexity of the key may further be checked, and the vehicle owner may be reminded to change the key regularly.

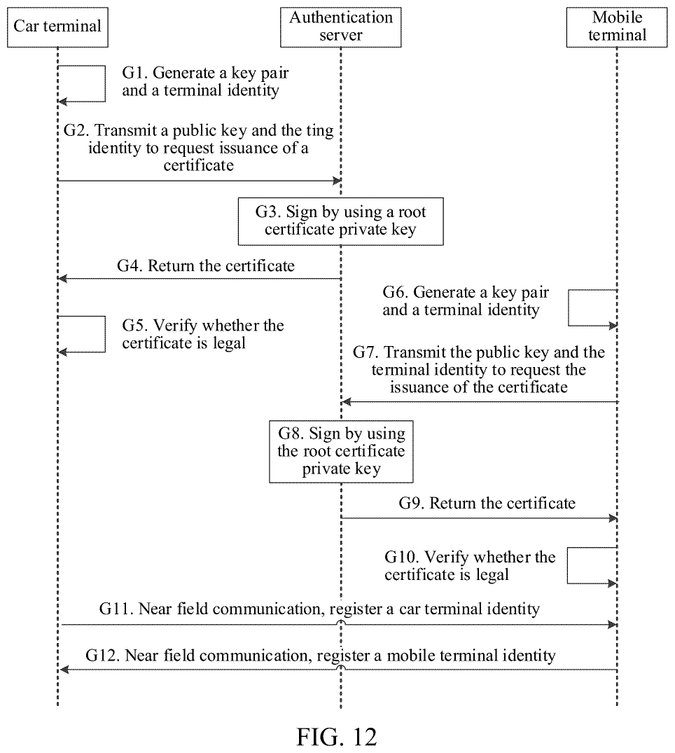

With reference to the foregoing description. For ease of understanding, referring to FIG. 12, FIG. 12 is a schematic diagram showing an interaction process based on an Internet of Vehicles system according to an embodiment of this application. As shown in the figure, specifically,
in operation G1, the car terminal is pre-installed with a root certificate of the authority before delivery. During initialization after delivery, the car terminal generates the car terminal public key and the car terminal private key. The car terminal private key is stored by the car terminal itself and is not leaked.

In operation G2, the car terminal obtains its own CID and binds the car terminal public key. Based on this, the car terminal initiates an HTTPS request or a TLS request to the authentication server of the authority to apply for issuance of a certificate.

In operation G3, after receiving the request transmitted by the car terminal, the authentication server of the authority may perform digital signature on the CID and the car terminal public key by using the target private key (that is, a root certificate private key) to form the second certificate.

In operation G4, the authentication server of the authority feeds back the second certificate to the car terminal through an HTTPS channel or a TLS channel, for the car terminal to store the second certificate.

In operation G5, after receiving the second certificate, the car terminal verifies whether a signature of the second certificate is correct through the root certificate pre-installed in operation G1 to ensure legality of the second certificate.

In operation G6, the user downloads an APP to the mobile terminal, and the APP has a built-in root certificate of the authority. This process may be provided by an SDK of the APP. After the user logs in to the APP, a corresponding mobile terminal public key and a corresponding mobile terminal private key are generated based on different MIDs (for example, a vehicle owner account or a mobile phone number). The mobile terminal private key is stored by the mobile terminal itself and is not leaked.

In operation G7, the mobile terminal binds the MID to the mobile terminal public key. Based on this, the mobile terminal initiates an HTTPS request or a TLS request to the authentication server of the authority to apply for issuance of a certificate.

In operation G8, after receiving the request transmitted by the mobile terminal, the authentication server of the authority may perform digital signature on the MID and the mobile terminal public key by using the target private key (that is, a root certificate private key) to form the first certificate.

In operation G9, the authentication server of the authority feeds back the first certificate to the mobile terminal through the HTTPS channel or the TLS channel, for the mobile terminal to store the first certificate.

In operation G10, after receiving the first certificate, the mobile terminal verifies whether a signature of the first certificate is correct through the root certificate pre-installed in operation G6 to ensure legality of the first certificate.

After the car terminal and the mobile terminal have a credible and peer security environment, a relationship between the car terminal and the mobile terminal (that is, the vehicle owner APP) needs to be bound. This operation is usually performed offline by the vehicle owner after purchasing and picking up the vehicle for the first time. Data transmission is performed through the Bluetooth protocol, and the like, so that the security risk is small.

In operation G11, the car terminal exchanges the CID to the vehicle owner APP of the mobile terminal through the Bluetooth protocol or another secure channel, for the vehicle owner APP to store.

In operation G12, the vehicle owner APP of the mobile terminal exchanges the MID to the car terminal through the Bluetooth protocol or another secure channel, for the car terminal to store.

The mobile terminal and the car terminal exchange certificates with each other during communication. Both parties verify an identity of the other party and determine whether the identity is the same as the registered identity. The identity is verified by the root certificate and cannot be forged. After both parties verify identities, that is, exchanging keys with each other, secure communication may be performed.

This application resolves a security and trust requirement for direct connection between the vehicle owner and the vehicle through the P2P network in the Internet of Vehicles. On one hand, the key and certificate system is extended, so that both the car terminal and the mobile terminal are equivalent to a security and trust level of a server deployed in an equipment room. On the other hand, a mutual trust relationship between the vehicle owner and the car terminal is utilized, and the vehicle owner usually does not take the initiative to damage his/her own vehicle. Finally, communication space between vehicle owners is isolated from each other and not invaded with each other. Based on this, the secure communication requirement of the car terminal and the mobile terminal is ensured, and a high privacy protection standard required by supervision is satisfied.

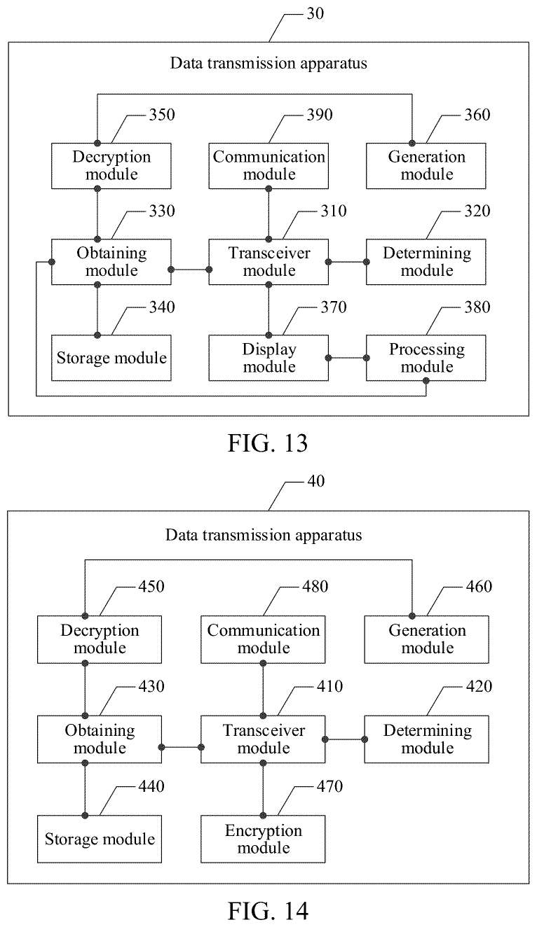

A data transmission apparatus in this application is described below in detail. Referring to FIG. 13, FIG. 13 is a schematic diagram of a data transmission apparatus according to an embodiment of this application. The data transmission apparatus 30 includes:
a transceiver module 310, configured to receive a first certificate transmitted by a first device, and transmit a second certificate to the first device;
a determining module 320, configured to determine a first public key and a first terminal identity based on the first certificate if both the first certificate and the second certificate are valid certificates, the first public key and a first private key being a key pair generated by the first device, and the first terminal identity being an identity corresponding to the first device, where
the transceiver module 310 is further configured to receive a data access request transmitted by the first device if both the first terminal identity and a second terminal identity are registered identities, the data access request being encrypted by the first device by using a second public key or the first private key, the second public key being obtained by the first device based on the second certificate, the second public key and a second private key being a key pair generated by the second device, and the second terminal identity being an identity corresponding to the second device; and
the transceiver module 310 is further configured to transmit target data to the first device in response to the data access request transmitted by the first device, the target data being encrypted by the second device by using the first public key or the second private key.

In some embodiments, based on the embodiment corresponding to FIG. 13, in another embodiment of the data transmission apparatus 30 provided in the embodiments of this application, the data transmission apparatus 30 further includes an obtaining module 330 and a storage module 340, where
the obtaining module 330 is configured to obtain a second public key and a second private key before the second certificate is transmitted to the first device;
the storage module 340 is configured to store the second private key;
the transceiver module 310 is further configured to transmit the second public key and the second terminal identity to an authentication server, so that the authentication server signs the second public key and the second terminal identity by using a target private key, to obtain the second certificate; and
the transceiver module 310 is further configured to receive the second certificate transmitted by the authentication server.

In some embodiments, based on the embodiment corresponding to FIG. 13, in another embodiment of the data transmission apparatus 30 provided in the embodiments of this application, the data transmission apparatus 30 further includes a decryption module 350 and a generation module 360, where
the decryption module 350 is configured to decrypt the second certificate by using a target public key to obtain a second target signature after the second certificate transmitted by the authentication server is received, the target public key and the target private key being a key pair generated by the authentication server;
the generation module 360 is configured to perform hash calculation on the second public key and the second terminal identity to obtain a second target digest; and
the storage module 340 is further configured to store the second certificate if the second target signature is consistent with the second target digest.

In some embodiments, based on the embodiment corresponding to FIG. 13, in another embodiment of the data transmission apparatus 30 provided in the embodiments of this application,
the decryption module 350 is further configured to decrypt the first certificate by using a target public key to obtain a first digital signature after the first certificate transmitted by the first device is received, the target public key being a public key generated by the authentication server;
the obtaining module 330 is further configured to obtain a first to-be-verified public key and a first to-be-verified identity from the first certificate;
the generation module 360 is further configured to perform hash calculation on the first to-be-verified public key and the first to-be-verified identity to obtain a first message digest;
the determining module 320 is further configured to determine that the first certificate is a valid certificate if the first message digest is consistent with the first digital signature; and
the determining module 320 is further configured to use the first to-be-verified public key in the first certificate as the first public key, and use the first to-be-verified identity in the first certificate as the first terminal identity.

In some embodiments, based on the embodiment corresponding to FIG. 13, in another embodiment of the data transmission apparatus 30 provided in the embodiments of this application,
the transceiver module 310 is further configured to decrypt the data access request by using the second private key to obtain request data if the data access request is encrypted by the first device by using the second public key; or decrypt the data access request by using the first public key to obtain request data if the data access request is encrypted by the first device by using the first private key;
obtain original data based on the request data;
encrypt the original data by using the second private key to obtain the target data; or encrypt the original data by using the first public key to obtain the target data; and
transmit the target data to the first device, so that the first device decrypts the target data to obtain the original data, where if the target data is encrypted by using the second private key, the first device decrypts the target data by using the second public key, or if the target data is encrypted by using the first public key, the first device decrypts the target data by using the first private key.

In some embodiments, based on the embodiment corresponding to FIG. 13, in another embodiment of the data transmission apparatus 30 provided in the embodiments of this application,
the obtaining module 330 is further configured to obtain a first terminal identity set stored by the second device after the first public key and the first terminal identity are determined based on the first certificate, the first terminal identity set including M first registration ting identities registered for the second device, and M being an integer greater than or equal to 1; and
the determining module 320 is further configured to determine that the first terminal identity is a registered identity if the first terminal identity successfully matches a first registration terminal identity in the first terminal identity set.

In some embodiments, based on the embodiment corresponding to FIG. 13, in another embodiment of the data transmission apparatus 30 provided in the embodiments of this application, the data transmission apparatus 30 further includes a display module 370 and a processing module 380, where
the display module 370 is configured to display the first terminal identity set;
the processing module 380 is configured to remove, in response to a deletion operation for K first registration ting identities in the first terminal identity set, the K first registration ting identities from the first terminal identity set to obtain an updated first terminal identity set, K being an integer greater than or equal to 1 and less than or equal to M;
the display module 370 is further configured to display an identity adding control;
the display module 370 is further configured to display an identity adding region in response to a selection operation for the identity adding control; and
the processing module 380 is further configured to add T first registration ting identities to the first terminal identity set in response to an input operation for the identity adding region, to obtain an updated first terminal identity set, T being an integer greater than or equal to 1.

In some embodiments, based on the embodiment corresponding to FIG. 13, in another embodiment of the data transmission apparatus 30 provided in the embodiments of this application, the data transmission apparatus 30 further includes a communication module 390, where
the communication module 390 is configured to: before the first certificate transmitted by the first device is received, and the second certificate is transmitted to the first device, establish a Bluetooth connection to the first device when the second device and the first device enable a Bluetooth function, so that a communication connection is established between the second device and the first device;
or
the communication module 390 is further configured to: before the first certificate transmitted by the first device is received, and the second certificate is transmitted to the first device, establish a communication connection to the first device when the second device and the first device are connected to the same wireless fidelity;
or
a display module 370 is further configured to display a QR code before the first certificate transmitted by the first device is received, and the second certificate is transmitted to the first device, the QR code including a second terminal identity; and
the communication module 390 is further configured to establish a communication connection to the first device when the first device scans the QR code;
or
the display module 370 is further configured to display an information input region before the first certificate transmitted by the first device is received, and the second certificate is transmitted to the first device; and
the communication module 390 is further configured to establish a communication connection to the first device in response to the first terminal identity inputted for the information input region.

A data transmission apparatus in this application is described below in detail. Referring to FIG. 14, FIG. 14 is a schematic diagram of a data transmission apparatus according to another embodiment of this application. The data transmission apparatus 40 includes:
a transceiver module 410, configured to transmit a first certificate to a second device, and receive a second certificate transmitted by the second device; and
a determining module 420, configured to determine a second public key and a second terminal identity based on the second certificate if both the first certificate and the second certificate are valid certificates, the second public key and a second private key being a key pair generated by the second device, and the second terminal identity being an identity corresponding to the second device, where
the transceiver module 410 is configured to transmit a data access request to the second device if both a first terminal identity and the second terminal identity are registered identities, the data access request being encrypted by the first device by using the second public key or a first private key, a first public key and the first private key being a key pair generated by the first device, and the first terminal identity being an identity corresponding to the first device; and
the transceiver module 410 is configured to receive target data transmitted by the second device 410, the target data being encrypted by the second device by using the first public key or the second private key.

In some embodiments, based on the embodiment corresponding to FIG. 14, in another embodiment of the data transmission apparatus 40 provided in the embodiments of this application, the data transmission apparatus 40 further includes an obtaining module 430 and a storage module 440, where
the obtaining module 430 is configured to obtain the first public key and the first private key before the first certificate is transmitted to the second device;
the storage module 440 is configured to store the first private key;
the transceiver module 410 is further configured to transmit the first public key and the first terminal identity to an authentication server, so that the authentication server signs the first public key and the first terminal identity by using a target private key, to obtain the first certificate; and
the transceiver module 410 is further configured to receive the first certificate transmitted by the authentication server.

In some embodiments, based on the embodiment corresponding to FIG. 14, in another embodiment of the data transmission apparatus 40 provided in the embodiments of this application, the data transmission apparatus 40 further includes a decryption module 450 and a generation module 460, where
the decryption module 450 is configured to decrypt the first certificate by using a target public key to obtain a first target signature after the first certificate transmitted by the authentication server is received, the target public key and the target private key being a key pair generated by the authentication server;
the generation module 460 is configured to perform hash calculation on the first public key and the first terminal identity to obtain a first target digest; and
the storage module 440 is further configured to store the first certificate if the first target signature is consistent with the first target digest.

In some embodiments, based on the embodiment corresponding to FIG. 14, in another embodiment of the data transmission apparatus 40 provided in the embodiments of this application,
the decryption module 450 is further configured to decrypt the second certificate by using a target public key to obtain a second digital signature after the second certificate transmitted by the second device is received, the target public key being a public key generated by the authentication server;
the obtaining module 430 is further configured to obtain a second to-be-verified public key and a second to-be-verified identity from the second certificate;
the generation module 460 is further configured to perform hash calculation on the second to-be-verified public key and the second to-be-verified identity to obtain a second message digest;
the determining module 420 is further configured to determine that the second certificate is a valid certificate if the second message digest is consistent with the second digital signature; and
the determining module 420 is further configured to use the second to-be-verified public key in the second certificate as the second public key, and use the second to-be-verified identity in the second certificate as the second terminal identity.

In some embodiments, based on the embodiment corresponding to FIG. 14, in another embodiment of the data transmission apparatus 40 provided in the embodiments of this application, the data transmission apparatus 40 further includes an encryption module 470, where
the encryption module 470 is configured to: before the data access request is transmitted to the second device, encrypt request data by using the second public key to obtain the data access request; or encrypt request data by using the first private key to obtain the data access request; and
the transceiver module 410 is further configured to transmit the data access request to the second device after the data access request is transmitted to the second device, so that the second device decrypts the data access request to obtain the request data, where if the data access request is encrypted by using the second public key, the second device decrypts the data access request by using the second private key, or if the data access request is encrypted by using the first private key, the second device decrypts the data access request by using the first public key;
or
the decryption module 450 is further configured to: after the target data transmitted by the second device is received, decrypt, if the target data is obtained by the second device encrypting original data by using the second private key, the target data by using the second public key to obtain the original data; or decrypt, if the target data is obtained by the second device encrypting original data by using the first public key, the target data by using the first private key to obtain the original data.

In some embodiments, based on the embodiment corresponding to FIG. 14, in another embodiment of the data transmission apparatus 40 provided in the embodiments of this application,
the obtaining module 430 is further configured to obtain a second terminal identity set stored by the first device after the second public key and the second terminal identity are determined based on the second certificate, the second terminal identity set including N second registration ting identities registered for the first device, and N being an integer greater than or equal to 1; and
the determining module 420 is further configured to determine that the second terminal identity is a registered identity if the second terminal identity successfully matches a second registration terminal identity in the second terminal identity set.

In some embodiments, based on the embodiment corresponding to FIG. 14, in another embodiment of the data transmission apparatus 40 provided in the embodiments of this application, the data transmission apparatus 40 further includes a communication module 480, where
the communication module 480 is configured to: before the first certificate is transmitted to the second device, and the second certificate to the second device is received, establish a Bluetooth connection to the second device when the second device and the first device enable a Bluetooth function, so that a communication connection is established between the second device and the first device;
or
the communication module 480 is further configured to: before the first certificate is transmitted to the second device, and the second certificate to the second device is received, establish a communication connection to the second device when the second device and the first device are connected to the same wireless fidelity;
or
the communication module 480 is further configured to: before the first certificate is transmitted to the second device, and the second certificate to the second device is received, scan a QR code displayed on the second device to establish a communication connection to the first device, the QR code including the second terminal identity.

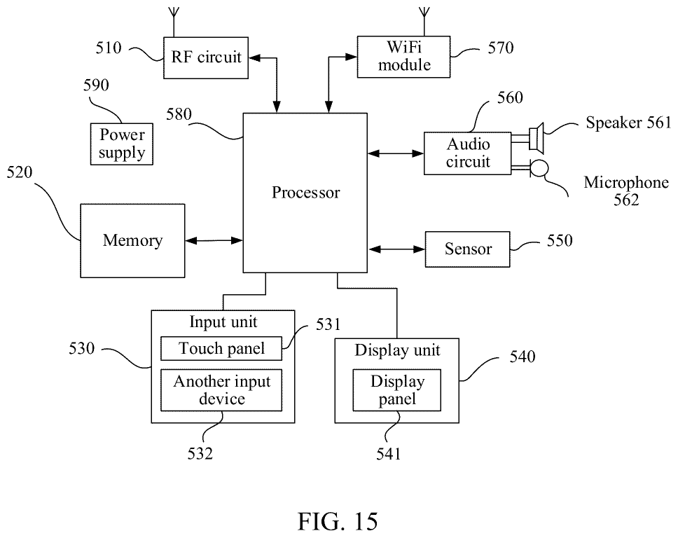

An embodiment of this application further provides a data transmission apparatus, which may be deployed on a terminal, as shown in FIG. 15, and for ease of description, only parts related to the embodiments of this application are shown. For specific technical details that are not disclosed, refer to the method part of the embodiments of this application. In the embodiments of this application, an example in which the terminal is a mobile phone is used for description.

FIG. 15 is a block diagram of a structure of a part of a mobile phone related to a terminal according to an embodiment of this application. Referring to FIG. 15, the mobile phone includes components such as: a radio frequency (RF) circuit 510, a memory 520, an input unit 530 (including a touch panel 531 and another input device 532), a display unit 540 (including a display panel 541), a sensor 550, an audio circuit 560 (connecting a speaker 561 and a microphone 562), a wireless fidelity (WiFi) module 570, a processor 580, and a power supply 590. A person skilled in the art may understand that the structure of the mobile phone shown in FIG. 15 does not constitute a limitation on the mobile phone. The mobile phone may include more or fewer components than those shown in the figure, or may combine some components, or may have different component arrangements.

The following describes the components of the mobile phone with reference to FIG. 15.

The memory 520 may be configured to store a software program and a module. The processor 580 runs the software program and the module stored in the memory 520, to implement various functional applications and data processing of the mobile phone. The memory 520 may mainly include a program storage region and a data storage region. The program storage region may store an operating system, an application program required by at least one function (for example, a sound playback function and an image display function), and the like. The data storage region may store data (for example, audio data and an address book) created based on the use of the mobile phone, and the like. In addition, the memory 520 may include a high speed random access memory, and may further include a non-volatile memory, such as at least one magnetic disk storage device, a flash memory device, or another volatile solid-state storage device.

The processor 580 is a control center of the mobile phone, and is connected to various parts of the entire mobile phone by using various interfaces and lines. By running or executing the software program and/or the module stored in the memory 520, and invoking data stored in the memory 520, the processor 580 executes various functions of the mobile phone and performs data processing. In some embodiments, the processor 580 may include one or more processing units. In some embodiments, the processor 580 may integrate an application processor and a modem processor. The application processor mainly processes an operating system, a user interface, an application program, and the like. The modem processor mainly processes wireless communication. The modem processor may not be integrated into the processor 580.

Although not shown in the figure, the mobile phone may further include a camera, a Bluetooth module, and the like. Details are not described herein again.

The operations performed by the terminal in the foregoing embodiments may be based on the structure of the terminal shown in FIG. 15.

The embodiments of this application further provide a computer device, including a memory and a processor, the memory having a computer program stored therein, and the processor, when executing the computer program, implementing the operations of the method described in the foregoing embodiments.

The embodiments of this application further provide a computer-readable storage medium, having a computer program stored therein, the computer program, when executed by a processor, implementing the operations of the method described in the foregoing embodiments.

The embodiments of this application further provide a computer program product, including a computer program, the computer program, when executed by a processor, implementing the operations of the method described in the foregoing embodiments.

In a specific implementation of this application, relevant data such as user information, in-vehicle information, and driving data are involved. When the foregoing embodiments of this application are applied to specific products or technologies, permission or consent of a user needs to be obtained, and collection, use, and processing of the relevant data need to comply with relevant laws, regulations, and standards of relevant countries and regions.

The foregoing embodiments are merely used for describing the technical solutions of this application, but are not intended to limit this application. Although this application is described in detail with reference to the foregoing embodiments, a person of ordinary skill in the art should understand that, modifications may still be made to the technical solutions described in the foregoing embodiments, or equivalent replacements may be made to some technical features in the technical solutions, as long as such modifications or replacements do not cause the essence of corresponding technical solutions to depart from the spirit and scope of the technical solutions of the embodiments of this application.

What is claimed is:

1. A data transmission method comprising:
receiving a first certificate transmitted by a first device, and transmitting a second certificate to the first device;
determining a first public key and a first terminal identity based on the first certificate in response to both the first certificate and the second certificate being valid certificates, the first public key and a first private key being a key pair generated by the first device, and the first terminal identity being an identity corresponding to the first device;
receiving a data access request transmitted by the first device in response to both the first terminal identity and a second terminal identity being registered identities, the data access request being encrypted by the first device using a second public key or the first private key, the second public key being obtained by the first device based on the second certificate, the second public key and a second private key being a key pair generated by a second device, and the second terminal identity being an identity corresponding to the second device; and
transmitting target data to the first device in response to the data access request, the target data is encrypted data obtained through encryption using the first public key or the second private key.

2. The method according to claim 1, further comprising, before transmitting the second certificate to the first device:
obtaining the second public key and the second private key;
storing the second private key;
transmitting the second public key and the second terminal identity to an authentication server, so that the authentication server signs the second public key and the second terminal identity using a target private key, to obtain the second certificate; and
receiving the second certificate transmitted by the authentication server.

3. The method according to claim 2, further comprising, after receiving the second certificate transmitted by the authentication server:
decrypting the second certificate using a target public key to obtain a target signature, the target public key and the target private key being a key pair generated by the authentication server;
performing hash calculation on the second public key and the second terminal identity to obtain a target digest; and
storing the second certificate in response to the target signature being consistent with the target digest.

4. The method according to claim 1, further comprising, after receiving the first certificate transmitted by the first device:
decrypting the first certificate using a target public key to obtain a digital signature, the target public key being generated by an authentication server;
obtaining, from the first certificate, a candidate public key to be verified and a candidate identity to be verified;
performing hash calculation on the candidate public key and the candidate identity to obtain a message digest; and
determining that the first certificate is a valid certificate in response to the message digest being consistent with the digital signature;
wherein determining the first public key and the first terminal identity based on the first certificate includes:
determining the candidate public key as the first public key, and determining the candidate identity as the first terminal identity.

5. The method according to claim 1, wherein transmitting the target data to the first device in response to the data access request includes:
decrypting the data access request to obtain request data using:
the second private key in response to the data access request being encrypted by the first device using the second public key; or
the first public key in response to the data access request being encrypted by the first device using the first private key;
obtaining original data based on the request data;
encrypting the original data to obtain the target data using the second private key to or the first public key; and
transmitting the target data to the first device, so that the first device decrypts the target data to obtain the original data using:
the second public key in response to the target data being encrypted using the second private key; or
the first private kay in response to the target data being encrypted using the first public key.

6. The method according to claim 1, further comprising, after determining the first public key and the first terminal identity based on the first certificate:
obtaining a terminal identity set stored by the second device, the terminal identity set including M registration ting identities registered for the second device, and M being an integer greater than or equal to 1; and
determining that the first terminal identity is a registered identity in response to the first terminal identity successfully matching one of the registration ting identities in the terminal identity set.

7. The method according to claim 6, further comprising:
updating the terminal identity set to obtain an updated terminal identity set, including at least one of:
displaying the terminal identity set, and removing, in response to a deletion operation, K registration ting identities from the terminal identity set to obtain the updated terminal identity set, K being an integer greater than or equal to 1 and less than or equal to M; or
displaying an identity adding control, displaying an identity adding region in response to a selection operation on the identity adding control, and adding T registration ting identities to the terminal identity set in response to an input operation on the identity adding region, to obtain the updated terminal identity set, T being an integer greater than or equal to 1.

8. The method according to claim 1, further comprising, before receiving the first certificate transmitted by the first device, and transmitting the second certificate to the first device:
establishing a Bluetooth connection to the first device in response to the second device and the first device enabling a Bluetooth function, so that a communication connection is established between the second device and the first device;
establishing a communication connection to the first device in response to the second device and the first device being connected to a same wireless hotspot;
displaying a QR code including the second terminal identity, and establishing a communication connection to the first device in response to the first device scanning the QR code; or
displaying an information input region, and establishing a communication connection to the first device in response to the first terminal identity inputted on the information input region.

9. A non-transitory computer-readable storage medium storing one or more computer programs that, when executed by one or more processors, cause the one or more processors to perform the method according to claim 1.

10. A computer device comprising:
one or more processors; and
one or more memories storing one or more program instructions that, when executed by the one or more processors, cause the one or more processors to:
receive a first certificate transmitted by a first device, and transmit a second certificate to the first device;
determine a first public key and a first terminal identity based on the first certificate in response to both the first certificate and the second certificate being valid certificates, the first public key and a first private key being a key pair generated by the first device, and the first terminal identity being an identity corresponding to the first device;
receive a data access request transmitted by the first device in response to both the first terminal identity and a second terminal identity being registered identities, the data access request being encrypted by the first device using a second public key or the first private key, the second public key being obtained by the first device based on the second certificate, the second public key and a second private key being a key pair generated by a second device, and the second terminal identity being an identity corresponding to the second device; and
transmit target data to the first device in response to the data access request, the target data being data obtained through encryption using the first public key or the second private key.

11. The computer device according to claim 10, wherein the one or more program instructions, when executed by the one or more processors, further cause the one or more processors to, before transmitting the second certificate to the first device:
obtain the second public key and the second private key;
store the second private key;
transmit the second public key and the second terminal identity to an authentication server, so that the authentication server signs the second public key and the second terminal identity using a target private key, to obtain the second certificate; and
receive the second certificate transmitted by the authentication server.

12. A data transmission method, performed by a first device, comprising:
transmitting a first certificate to a second device, and receiving a second certificate transmitted by the second device, the first device being configured to generate a first key pair including a first public key and a first private key, a first terminal identity corresponding to the first device, the second device being configured to generate a second key pair including a second public key and a second private key, and a second terminal identity corresponding to the second device;
determining the second public key and the second terminal identity based on the second certificate in response to both the first certificate and the second certificate being valid certificates;
transmitting a data access request to the second device in response to both the first terminal identity and the second terminal identity being registered identities, the data access request being encrypted by the first device using the second public key or the first private key; and
receiving target data from the second device, the target data being encrypted data obtained through encryption using the first public key or the second private key.

13. The method according to claim 12, further comprising, before transmitting the first certificate to the second device:
obtaining the first public key and the first private key;
storing the first private key;
transmitting the first public key and the first terminal identity to an authentication server, so that the authentication server signs the first public key and the first terminal identity using a target private key, to obtain the first certificate; and
receiving the first certificate transmitted by the authentication server.

14. The method according to claim 13, further comprising, after receiving the first certificate transmitted by the authentication server:
decrypting the first certificate using a target public key to obtain a target signature, the target public key and the target private key being a key pair generated by the authentication server;
performing hash calculation on the first public key and the first terminal identity to obtain a target digest; and
in response to the target signature being consistent with the target digest, storing the first certificate.

15. The method according to claim 12, further comprising, after receiving the second certificate transmitted by the second device:
decrypting the second certificate using a target public key to obtain a digital signature, the target public key being generated by the authentication server;
obtaining, from the second certificate, a candidate public key to be verified and a candidate identity to be verified;
performing hash calculation on the candidate public key and the candidate identity to obtain a message digest; and
determining that the second certificate is a valid certificate in response to the message digest being consistent with the digital signature;
wherein determining the second public key and the second terminal identity based on the second certificate includes:
determining the candidate public key as the second public key, and determining the candidate identity as the second terminal identity.

16. The method according to claim 12, further comprising at least one of:
before transmitting the data access request to the second device, encrypting request data to obtain the data access request using the second public key or using the first private key;
after transmitting the data access request to the second device, transmitting a data access request to the second device, so that the second device decrypts the data access request to obtain the request data using:
the second private key in response to the data access request being encrypted using the second public key, or
the first public kay in response to the data access request being encrypted using the first private key; or
after receiving the target data transmitted by the second device, decrypting the target data to obtain original data using:
the second public kay in response to the target data being obtained by the second device encrypting the original data using the second private key; or
the first private key in response to the target data being obtained by the second device encrypting the original data using the first public key.

17. The method according to claim 12, further comprising, after determining the second public key and the second terminal identity based on the second certificate:
obtaining a terminal identity set stored by the first device, the terminal identity set including N second registration ting identities registered for the first device, and N being an integer greater than or equal to 1; and
determining that the second terminal identity is a registered identity in response to the second terminal identity successfully matching a registration terminal identity in the terminal identity set.

18. The method according to claim 12, further comprising, before transmitting the first certificate to the second device, and receiving the second certificate transmitted by the second device:
establishing a Bluetooth connection to the second device in response to the second device and the first device enabling a Bluetooth function, so that a communication connection is established between the second device and the first device;
establishing a communication connection to the second device in response to the second device and the first device being connected to a same wireless hotspot; or
scanning a QR code displayed on the second device to establish a communication connection to the first device, the QR code including the second terminal identity.

19. A computer device comprising:
one or more processors; and
one or more memories storing one or more program instructions that, when executed by the one or more processors, cause the one or more processors to perform the method according to claim 12.

20. A non-transitory computer-readable storage medium storing one or more computer programs that, when executed by one or more processors, cause the one or more processors to perform the method according to claim 12.
